(19) United States
(12) Patent Application Publication
(10) Pub. No.: US 2025/0003810 A1
(43) Pub. Date: Jan. 2, 2025

(54) METHOD OF MANUFACTURING NTC SENSORS

(71) Applicant: TDK Electronics AG, München (DE)

(72) Inventors: Gerhard Hojas, Söding-St. Johann (AT); Subramanian Ravichandran, Deutschlandsberg (AT); Dhananjay Chavan, Berlin (DE); Wolfgang Fail, Wies (AT)

(21) Appl. No.: 18/576,343

(22) PCT Filed: May 30, 2022
(86) PCT No.: PCT/EP2022/064569

§ 371 Date: Jan. 3, 2024

(30) Foreign Application Priority Data
Jul. 19, 2021 (DE) 102021118566.1

(51) Int. Cl. G01K 7/22; H01C 1/14; H01C 17/00

(52) U.S. Cl. CPC G01K 7/22; H01C 1/1413; H01C 17/00

(57) ABSTRACT

In an embodiment a method for assembling NTC sensor includes providing an NTC thermistor element and connection wires having terminals for contacting the NTC thermistor element; and self-heating the NTC thermistor element while applying an electrical current during the following steps: dispensing solder paste to the terminals of the connection wires, applying the connection wires to the NTC thermistor element and melting the solder paste by a generated heat of the NTC thermistor element thereby forming solder bonds between the NTC thermistor element and the connection wires.

### CROSS-REFERENCE TO RELATED APPLICATIONS

This patent application is a national phase filing under section 371 of PCT/EP2022/064569, filed May 30, 2022, which claims the priority of German patent application 102021118566.1, filed Jul. 19, 2021, each of which is incorporated herein by reference in its entirety.

### TECHNICAL FIELD

The present invention concerns a method of manufacturing NTC sensors comprising a method of assembling NTC sensors and a method for coating NTC sensors comprising several process steps in a specified order. The present invention further concerns an NTC thermistor element.

### BACKGROUND

Previously available NTC thermistor temperature sensors using plastic coatings are manufactured with conventional thermally controlled assembly and coating technologies.

The electrical resistance of an NTC thermistor material changes with changing temperatures. In particular, the resistance of the NTC thermistor decreases with increasing temperatures. The NTC thermistor material is integrated in an electric circuit by means of connection wires. A plastic housing may protect the thermistor from environmental impacts.

Examples of NTC thermistor elements are known from document DE 10 2005 017 816 A1.

### SUMMARY

Embodiments provide improves the known methods for manufacturing NTC sensors.

The method concerns several manufacturing steps.

In a first aspect the invention concerns a method of assembling NTC sensors comprising several steps.

In one step, an NTC thermistor element (NTC stands for negative temperature coefficient) and connection wires having terminals for contacting the NTC thermistor element are provided.

The NTC thermistor element may be configured in a disk or a block shape configured that can be used for a surface-mount device (SMD).

The NTC thermistor element may comprise an NTC ceramic material. The NTC ceramic material works as an electrical resistance, wherein the resistance changes depending on the internal temperature of the material. The NTC ceramic material can be self-heated by applying an electrical current.

The NTC thermistor element may further comprise two electrodes configured on opposing surfaces of the NTC ceramic material. The electrodes allow to contact the NTC thermistor element electrically and to integrate it in an electric circuit. The electrodes may comprise a material showing good electrical conductivity such as a metal, a noble metal or a metal alloy.

Alternatively, the NTC thermistor element can be designed as a multilayer component. The multilayer component comprises several layers of an NTC ceramic material and inner electrodes arranged in between. The inner electrodes comprise a metallic and electrically conductive material.

The multilayer component is formed as a stack of multiple ceramic layers and inner electrodes and preferably has an overall cuboid structure.

In the described embodiment, the inner electrodes can be electrically contacted by outer electrodes on the surfaces of the multilayer component. The outer electrodes are preferably applied to two opposite side surfaces of the multilayer component. The outer electrodes can be cap-shaped and cover different side surfaces of the multilayer component. Preferably, the inner electrodes stacked in the multilayer component are each alternately connected to the two oppositely positioned outer electrodes.

The outer electrodes comprise metallization layers of, for example, silver or gold, which are applied, for example, via a screen-printing process with subsequent thermal treatment.

The electrical resistance of such a multilayer component can be defined very precisely. Resistance tolerances of less than 1% can thus be achieved.

The connection wires are electrically conductible wires comprising an electrical conductible metal or a metal alloy. The connection wire may be isolated by a polymer coating. At least a portion at the terminal of the connection wire may not be isolated by the coating.

In a further step, the NTC thermistor element is self-heated by application of an electrical current. Self-heating is maintained during the following steps.

In a first step, solder paste is dispensed to the terminals of the connection wires. The solder paste may comprise different metals such as lead, tin, zinc, silver, copper, gold, antimony and bismuth. Preferably, the solder paste may be free of lead. Furthermore, the solder paste may be impregnated with a fluxing agent.

Dispensed solder paste after heating may result in a flame like shape to the head of the connection wire, wherein the head is the terminal of the connection wire.

In a second step, the connection wires are applied to the NTC thermistor element. In particular, the connection wires may be applied to the electrodes of the NTC thermistor element on two opposing sides of the element. The connection wires are applied to NTC thermistor element in such way, that the solder paste is in direct contact with the NTC thermistor element, in particular the electrodes.

In a third step, the solder paste is melted by the heat generated by the NTC thermistor element. By melting of the solder paste solder bonds are formed between the NTC thermistor elements, in particular the electrodes, and the connection wires, in particular the terminals.

Thereby, a closed electric circuit is formed, comprising a closed electrical connection between a terminal of a first connection wire, a first solder bond, a first electrode of the NTC thermistor element, the NTC thermistor material, a second electrode of the NTC thermistor element, a second solder bond and a terminal of a second connection wire.

The described steps may be conducted in the given order or in any other order applicable. Here and in the following, the designations ‘first’, ‘second’ etc. do not determine a mandatory order of the process steps.

In an embodiment, the NTC thermistor element is heated to more than 200° C.

Such a temperature can be reached without changes of properties of the NTC thermistor material.

Different than when heating the NTC thermistor material in an oven, the phase constitution of the NTC thermistor material does not change remarkably during the described self-heating process. Therefore, following time-consuming aging processes can be omitted or can be drastically shortened. A following coating process may be conducted immediately after the soldering process and without additional thermal treatment.

Preferably, the electrical current to heat the NTC thermistor is applied by the connection wires themselves to the NTC thermistor.

In an alternative embodiment, the electrical current is applied by auxiliary electrodes applied to the NTC thermistor. The auxiliary electrodes are applied temporarily and reversible.

The auxiliary electrodes may be applied on two opposing surfaces of the NTC thermistor element.

The auxiliary electrodes may be comprised in a holding structure in which the NTC thermistor elements are fixed during manufacturing.

The auxiliary electrodes may contact the electrodes of the NTC thermistor element.

Thereby, a closed electric circuit is formed, comprising a closed electrical connection between a first auxiliary electrode, a first electrode of the NTC thermistor element, the NTC thermistor material, a second electrode of the NTC thermistor element and a terminal of a second auxiliary electrode.

In the described process, the solder paste is melted by the heat generated by the NTC thermistor element. Thereby solder bonds are formed between the NTC thermistor element and the connection wires. Thereafter, the auxiliary electrodes may be removed and self-heating of the NTC thermistor element is stopped.

In an embodiment, the solder bonds between the connection wires and the NTC thermistor element show a high strength. The solder bonds can withstand a tensile force of at least 6 N, preferably up to 7 N, even more preferably up to 8 N.

In an embodiment, two connection wires are applied on two opposing surfaces of the NTC thermistor element, in particular on two opposing electrodes configured at opposing surfaces of the NTC thermistor element.

In an embodiment, the solder paste is impregnated by dipping the connection wires into a reservoir containing fluxing agent.

The solder paste is impregnated with fluxing agent before the wires are applied on the NTC thermistor element and before the solder paste is melted.

Therefore, no fluxing agent is wasted by unwanted impregnation of the NTC thermistor element.

Preferably, the solder paste is impregnated by dipping the connection wires into sponges with fluxing agent.

In such way the fluxing agent can be applied targeted and with a minimum waste of fluxing agent.

In soldering of metals, fluxing agents serve several purposes. The fluxing agent removes oxidized metal from the surface to be soldered, seals out air thus preventing further oxidation and improves wetting characteristics of the liquid solder.

In an embodiment, the solder paste melts and forms the solder bonds in preferably less than 30 seconds.

In this time span, the NTC thermistor element and a surface of the NTC thermistor element on which the solder paste is applied can be heated to a determined temperature, the solder paste is melted and the solder bond is formed.

The required temperature depends on the composition of the solder paste. The NTC thermistor element may be configured to be heated to more than 200° C. and preferred to a temperature between 200° C. and 400° C. by application of an electric current.

Since the solder paste is melted directly by the self-heated NTC thermistor element, on which the solder is applied, thermal pre-and post-treatment steps can be omitted.

Therefore, the soldering process can be shortened in comparison with conventional processes.

In a second aspect the invention concerns a method of coating NTC sensors comprising several steps.

The method of the second aspect may further comprise all steps of the method of the first aspect.

The method for coating NTC sensors comprises the step of providing an NTC sensor comprising an NTC thermistor element and connection wires fixed on the NTC thermistor element.

The NTC thermistor element and the connection wires may be processed as described in the first aspect. The NTC sensor may be provided by running the process of the first aspect.

In one step, the NTC thermistor element is self-heated by application of an electrical current. The self-heating is maintained during the following process steps.

In a first step, the NTC thermistor element is dipped in a coating raw material.

The coating raw material may be provided as a polymer powder or as a resin. Typical coating materials may comprise polymers such as, for example, perfluoroalkoxy alkane (PFA), Teflon, polyurethane (PU), polyamide (PA), polyimide (PI), silicon, polyester, polyacrylate, epoxy polymers, resins and epoxy resins.

The coating material may be stored in a coating raw material reservoir, for example in a tub.

In a second step, the coating raw material is melted by the heat generated by the NTC thermistor element. The required heat depends on the used coating raw material.

In a third step, a coating layer is formed, the layer enclosing the NTC thermistor element and adjacent portions of the connection wires.

The coating layer is formed from the melted coating raw material. Preferably, the coating layer comprises only one single layer of polymer material.

By the disclosed process steps, the coating layer can be applied by a minimum demand of heating energy and coating raw material. Only the raw material adjacent to the self-heated surface of the NTC thermistor element is melted and forms the coating layer. Further coating raw material provided in the reservoir remains in powder or resin form.

In an embodiment, the NTC thermistor element is heated to more than 170° C.

Such a temperature can be reached without changes of properties of the NTC thermistor material.

Different than when heating the NTC thermistor material in an oven, the phase constitution of the NTC thermistor material does not change remarkably during the described self-heating process. Therefore, following time-consuming thermal processing steps can be omitted or can be drastically shortened.

Furthermore, because of the targeted heating of only small amounts of coating raw material, thermal post-treatment steps for curing and tempering of the coating material can be shortened to a time span of less than two hours and preferably to less than one hour.

The required temperature depends on the composition of the coating raw material. The NTC thermistor element may be configured to be heated to more than 80° C. or more than 100° C. or more than 170° C. and preferred to a temperature between 80° C. and 350° C. by application of an electric current.

In an embodiment, the electrical current is applied by using the connection wires which are fixed to the NTC thermistor element.

Preferably, two connection wires are applied on two opposing surfaces of the NTC thermistor element, in particular on two opposing electrodes configured at opposing surfaces of the NTC thermistor element.

Thereby, a closed electric circuit is formed, comprising a closed electrical connection between a first connection wire, a first electrode of the NTC thermistor element, the NTC thermistor material, a second electrode of the NTC thermistor element and a second connection wire.

In an embodiment, the coating raw material melts and forms the coating layer in preferably less than 30 seconds.

In this time span, the NTC thermistor element and a surface of the NTC thermistor element on which the coating raw material is applied can be heated to a determined temperature, the coating raw material adjacent to the surface is melted and the coating layer is formed.

In another embodiment, the coating raw material melts and forms the coating layer in less than 50 seconds.

By choosing a short time span only one coating layer is formed. Therefore, the demand for raw material is minimized.

Since the coating raw material is melted directly by the self-heated NTC thermistor element, on which the raw material is applied, no thermal pre-treatment or post-treatment steps are necessary to form the coating layer.

Therefore, the coating process can be shortened in comparison with conventional processes.

In a third aspect the invention concerns a method of manufacturing an NTC sensors comprising any one of the steps of the assembling method and any one the steps of the coating method as described regarding the first and the second aspect.

The manufacturing method of the first aspect may comprise all steps of the method of the first aspect and may further comprise all steps of the method of the second aspect.

The first two aspects of the invention may also comprise all steps of the third aspect.

A method of manufacturing NTC sensors comprises several assembling and several coating steps.

In particular, the manufacturing method comprises the following steps which may be conducted in the given order.

In one step, an NTC thermistor element and connection wires having terminals for contacting the NTC thermistor element are provided.

In a following step, the NTC thermistor is self-heated by the application of an electric current, preferably by the connection wires themselves or alternatively by using auxiliary electrodes. Self-heating is maintained during the following three steps.

In a first step, solder paste is dispensed to the terminals of the connection wires.

In a second step, the connection wires are applied to the NTC thermistor element.

In a third step, the solder paste is melted by the heat generated by the NTC thermistor element. Thereby solder bonds are formed between the NTC thermistor element and the connection wires.

After the third step, the optional auxiliary electrodes may be removed and self-heating of the NTC thermistor element is stopped.

In the following, the NTC sensor comprising the NTC thermistor element and the connection wires fixed on the NTC thermistor element is further processed.

In a fourth step, the NTC thermistor element is self-heated by application of an electrical current. The electrical current may be applied by the connection wires. Self-heating may be maintained to following steps.

In a fifth step, the NTC thermistor element is dipped in a coating raw material.

In a sixth step, the coating raw material is melted by the heat generated by the NTC thermistor element.

In a seventh step, a coating layer enclosing the NTC thermistor element and adjacent portions of the connection wire is formed.

Thereafter, the self-heating of the NTC thermistor element may be stopped.

No further thermal post-treatment steps may be required.

Alternatively, thermal post-treatment steps may be conducted to cure and/or to temper the coating. These thermal post-treatment steps may be conducted in less than one hour.

In an embodiment, several NTC thermistor elements are handled simultaneously. In a preferred embodiment, at least five NTC thermistor elements are handled simultaneously. Simultaneous handling is allowed by the simplification of conventional production steps.

Simultaneous handling allows mass production of the NTC sensor.

The invention further concerns an NTC sensor element comprising an NTC thermistor element and two connection wires fixed on opposing sides of the NTC thermistor element by solder bonds and a single-layer coating completely enclosing the NTC thermistor element and the solder bonds.

In an embodiment, the solder bonds between the connection wires and the NTC thermistor element show a high strength. The solder bonds can withstand a tensile force of at least 6 N. This strength is at least comparable to the strength of conventional soldered bonds. Preferably, the solder bonds show a high strength up to 7 N, even more preferably up to 8 N.

The NTC sensor element may be manufactured by the method according to any one of the aspects 1 to 3 of the present invention.

The NTC sensor element may further be configured according to any embodiment of any one of the aspects 1 to 3.

In an embodiment, the NTC thermistor element has a block shape.

In a further embodiment, the NTC thermistor element has a disk shape.

The dimensions of the NTC thermistor element may not exceed 30 mm×30 mm×5 mm and may preferably not exceed 3 mm×3 mm×1 mm.

The disk or the block may have a circular, elliptical, rectangular or quadratic shape with or without rounded corners.

The NTC thermistor element may comprise an NTC ceramic material. The NTC ceramic material works as an electrical resistance, wherein the resistance changes depending on the internal temperature of the material. The NTC ceramic material can be self-heated by applying an electrical current.

The NTC thermistor element may further comprise two electrodes configured on opposing surfaces of the NTC ceramic material. The electrodes allow to contact the NTC thermistor element electrically and to integrate it in an electric circuit. The electrodes may comprise a material showing good electrical conductivity such as a metal, a noble metal or a metal alloy.

The thickness of the current path, which is the dimension of the NTC thermistor element from one electrode to the other, may not exceed 5 mm (includes dimensions of the electrodes in it) and may preferably not exceed 1 mm.

The surface of the NTC thermistor element perpendicular to the direction of the current path may have a circular, elliptical, rectangular or quadratic shape and may not exceed 30 mm×30 mm and may preferably not exceed 3 mm×3 mm.

The connection wires are electrically conductible wires comprising an electrical conductible metal or a metal alloy. The connection wire may be isolated by a polymer coating. At least a portion at the terminal of the connection wire may not be isolated by the coating.

In the following, the embodiments of the invention will be explained in more detail with reference to accompanied figures. Similar or apparently identical elements in the figures are marked with the same reference signs. The figures and the proportions in the figures are not scalable. The invention is not limited to the following embodiments. The figures show:

### BRIEF DESCRIPTION OF THE DRAWINGS

FIG. 1 shows a first embodiment of a connection wire;

FIG. 2 shows the first embodiment of the connection wire with solder bump;

FIG. 3 shows a diagram of the temperature and electrical resistance profile inside the NTC thermistor element during a soldering process;

FIG. 4 shows a first embodiment of a NTC thermistor element before the coating process;

FIG. 5 shows a diagram of the temperature and electrical resistance profile inside the NTC thermistor element during a coating process; and

FIG. 6 shows the first embodiment of the NTC thermistor element with applied coating.

### DETAILED DESCRIPTION OF ILLUSTRATIVE EMBODIMENTS

In the following, an exemplary manufacturing process of an NTC (negative temperature coefficient) thermistor element is described with reference to the figures. The NTC thermistor element 4 is intended for use in an NTC sensor.

In a first process section, an NTC thermistor element 4 is provided with connection wires 1. The connection wires 1 are provided by soldering on two opposite surfaces of the NTC thermistor element 4. Two electrodes 5 are configured on the two opposite surfaces of the NTC thermistor element 4. The Connection wires 1 are applied to the surface of the electrodes 5.

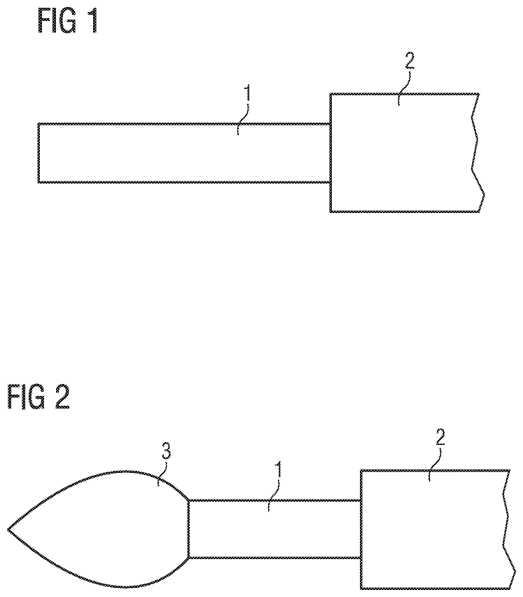

First, the connection wires 1 are provided as shown in FIG. 1. The connection wires 1 are mainly made of a material with good electrical conductivity, such as a noble metal like silver or copper or a corresponding alloy. The wires 1 may have a coating isolating layer 2 of an electrically non-conductive polymer material. The isolating layer 2 is not present at the terminals of the wires 1, to which solder paste is subsequently applied.

In a first production step, the wires 1, preferably five pairs of two wires 1 each, are clamped in a holding device. In this way, five sensors can subsequently be manufactured simultaneously. The terminals of the wires 1 that do not have a coat are now processed. Solder bumps 3 are applied to the free terminals of the wires 1 via a syringe. By applying the solder paste in a targeted manner, the amount of solder required can be minimized. The excess solder material, which is subsequently discarded, is reduced.

The wire terminal with the applied solder bump 3 is shown in FIG. 2.

In the next process step, the wires 1 with the applied solder bumps 3 are dipped into a reservoir of fluxing agent. The reservoir of fluxing agent may preferably be in the form of a sponge containing fluxing agent. The wires 1 are then pressed onto the sponge, solder bumps 3 first, to impregnate the solder bumps 3 with fluxing agent.

The NTC thermistor elements 4 are provided in a holder, preferably several elements at a time, for example five elements.

The wires 1 with solder bumps 3 are now applied to the NTC thermistor elements 4 on the two opposing surfaces comprising the electrodes 5.

An electric current of up to 1A depending on the resistance and the resistance-temperature (R-T-) curve of the NTC ceramic material is applied to the NTC thermistor elements 4 by the wires 1, resulting in their self-heating.

By self-heating of the NTC thermistor element up to over 200° C. the solder bumps 3 melt and a solid solder connection is formed between the NTC thermistor element 4 and the wires 1.

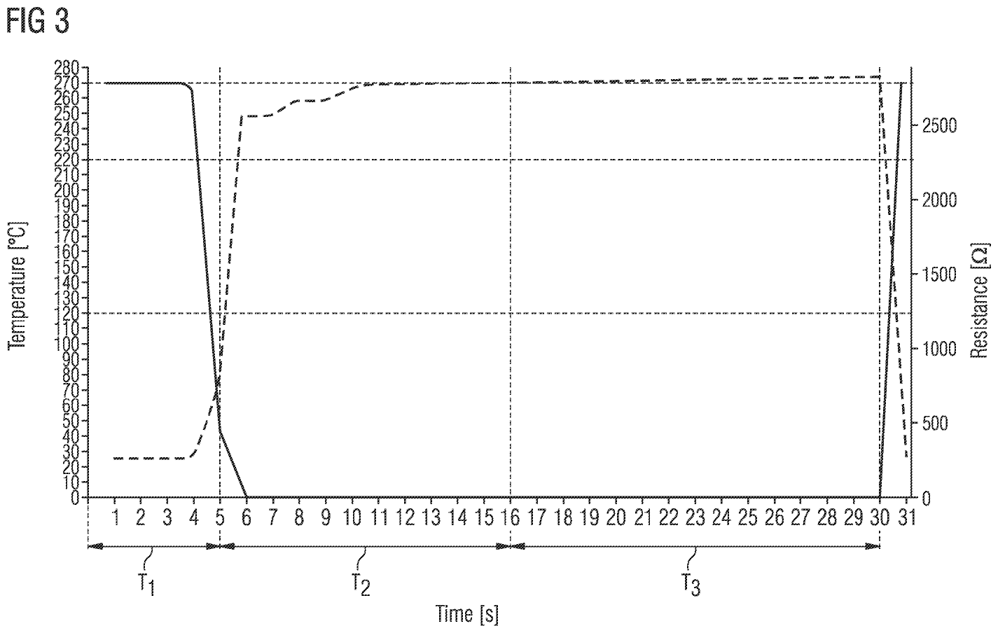

FIG. 3 shows the temperature profile during the soldering process.

During a time period T1, the NTC thermistor element 4 is preheated to above 120° C. At a temperature between 120° C. and 210° C., the fluxing agent is activated. In the present temperature profile, a temperature of 120° C. is reached after approximately 5 seconds (T₁). At a temperature of approx. 220÷10° C., the solder paste liquefies. After further 11 seconds (T₂), the maximum temperature of 270±5° C. is reached.

This maximum temperature of the soldering process is held for 14 seconds (T₃) to allow forming of the solder bump 3.

After a total time of 30 seconds, the soldering process is finished and the self-heating of the NTC thermistor element is stopped, i.e. the current applied for self-heating is switched off.

Since the NTC thermistor element 4 has by definition at high temperatures a high electric conductibility, the electrical resistance, which is also shown in FIG. 3, changes opposite to the temperature. During the soldering process at 270° C., the electrical resistance drops based on the corresponding R-T-curve.

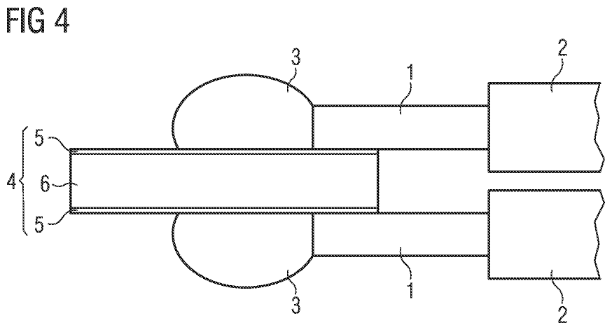

After the soldering process, the NTC sensor is in the configuration shown in FIG. 4. Two wires 1 are attached at their loose terminals via solder bumps 3 to electrodes 5 on opposite surfaces of the NTC thermistor element 4.

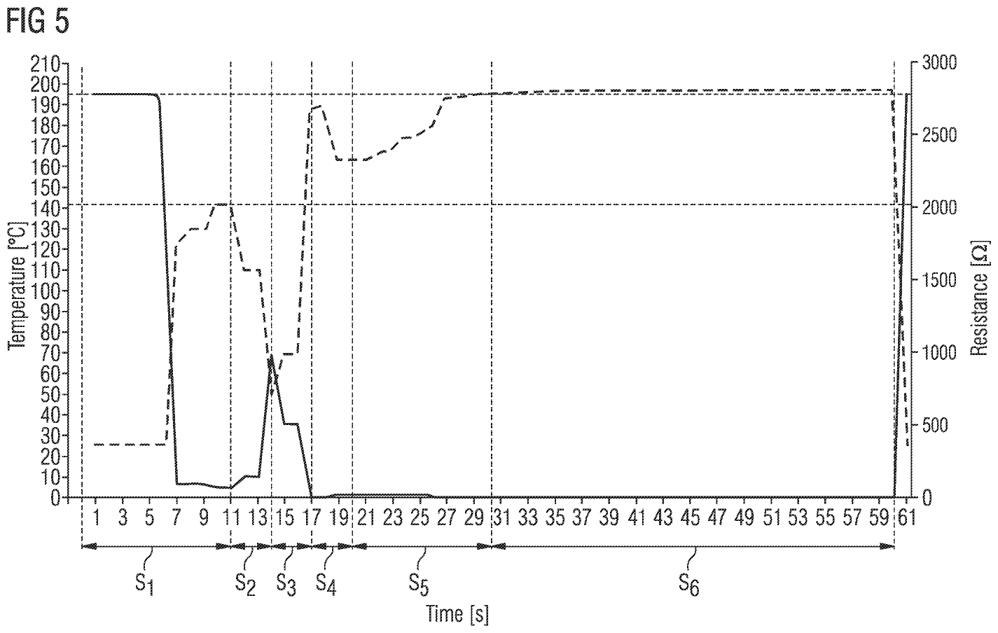

In the following, the coating process is carried out. The coating process is described with reference to the temperature diagram in FIG. 5. The NTC thermistor element 4 is self-heated by applying an electric current. For this purpose, current can be applied via the now attached connection wires 1.

In a first step, the NTC thermistor element 4 is preheated to a temperature of 140° C. within 11 seconds (S₁).

The preheated NTC thermistor element 4 is then immersed in a reservoir containing coating raw material. The coating raw material is in powder or resin form. In the described example the coating raw material may be in powder form. The immersion movement lasts approximately 3 seconds (S₂). As a result of the immersion in the powder of the coating raw material, which is cooler than the NTC element, the NTC thermistor element 4 cools down comparatively quickly to approximately 50° C. The coating raw material has approx. room temperature (around 25° C.).

Subsequently, the NTC thermistor element 4 in the reservoir of the coating raw material is heated again to approximately 170° C. in 3 seconds (S₃), so that the coating raw material powder adjacent to the NTC thermistor element 4 melts and forms a single coating layer 7 around the NTC thermistor element 4 and the portions of the connection wires 1 and the connecting solder bumps 3 adjacent thereto.

Subsequently, the NTC thermistor element 4 with the applied coating layer 7 is lifted out of the reservoir of coating raw material within approximately 3 seconds (S₄), whereby the NTC thermistor element 4 cools down to approximately 160° C. The coating layer 7 is then applied to the NTC thermistor element 4. After about 20 seconds, the actual coating process is thus completed. The coating layer 7 is then thermally post-treated to strengthen it.

In a pre-curing step, the NTC thermistor element 4 with the applied coating layer 7 is heated to 190° C. in 10 seconds (S₅). Then a curing temperature of approx. 195±5° C. is maintained for 30 seconds (S₆). After about 40 seconds, the curing process is completed and self-heating of the NTC thermistor element is stopped.

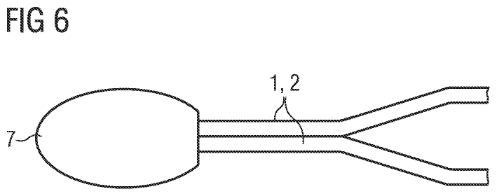

Thus the NTC sensor element shown in FIG. 6 has been obtained, in which the NTC thermistor element, the adjacent solder bumps 3 and the adjacent non-isolated portions of the connection wires 1 are enclosed in a coating 7.

The process described allows a uniform thin application of the coating material, so that the NTC thermistor element 4 is completely and uniformly enclosed after only one layer of coating material has been applied. The application of further coating layers 7 is thus not necessary. This means that the time and cost required to produce the coating can be significantly reduced.

The thin, single-layer coating 7 also eliminates the need for additional time-consuming thermal post-treatment steps. The thin coating 7 can be cured within the described 40 seconds.

If necessary, further post-treatment steps can be carried out. These steps, such as curing and tempering, are performed in less than one hour, achieving the required properties of the coating 7.

In conventional processes, the time required for such post-treatment steps is typically 8 hours for the curing process and 72 hours for the tempering process. Since the material can be applied less uniformly in conventional processes, more than two or even more than five layers of coating material are often required.

An exemplary NTC thermistor element, as shown in FIG. 6, is described below.

The NTC thermistor element 4 has a cuboid shape. The NTC thermistor element 4 comprises an NTC thermistor ceramic 6 which has a cuboid shape.

Electrodes 5 for electrical contact are provided on two opposite surfaces of the NTC thermistor ceramic 6. The entire NTC thermistor element 4 has dimensions not exceeding 3 mm×3 mm×1 mm.

Here, 1 mm is the measure of the thickness of the NTC thermistor element from the surface where one electrode 5 is applied to the surface where the other electrode 5 is applied. This thickness corresponds to the length of the current path that the applied current travels within the NTC thermistor element.

The surface perpendicular to the current path has dimensions not exceeding 3 mm×3 mm. Generally, the longer side of the surface points in the same direction as the connection wires 1 attached to the element, and the shorter side points in the direction perpendicular to the direction in which the connection wires 1 run.

The electrodes 5 are preferably electrodes comprising a material comprising at least one of silver, gold, copper, nickel, platinum or palladium and are applied to the thermistor material, for example, by screen printing or by sputtering.

Said connection wires 1 are attached to the electrodes 5 via solder bumps 3. The solder bumps 3 are made of a solderable material comprising various suitable metals, such as germanium, tin, silver, lead, antimony, bismuth, gold, zinc and copper. Preferably, the solderable material is lead-free.

For example, the connection wires 1 have a diameter of 0.25 mm and comprise a material with good electrical conductivity, such as copper. The connection wires 1 are coated by an electrically isolating layer 2 except at their terminals.

The diameter of the wires 1 with isolation is approximately 0.5 mm. Preferably, a high-temperature-resistant plastic, such as polyetheretherketone (PEEK), PFA, polytetrafluoro-ethylene (PTFE), fluorinated ethylene propylene (FEP), PA, PI or similar plastics are used for the isolation 2.

Alternatively, non-insulated wires may be used.

The NTC thermistor element 4 and the adjacent portion of the wires 1, in particular the non-isolated portion is surrounded by a single layer coating 7, for example a coating layer 7 comprising an epoxy resin or other epoxy polymer material. Further possible coating materials include PFA, Teflon or fluorinated epoxy materials.

The soldered joint between connection wires 1 and NTC thermistor element 4, soldered according to the described method, shows a high strength, at least comparable to the strength of conventional soldered joints. The soldered joint can withstand a tensile force of at least 6 N, preferably up to 7 N, even more preferably up to 8 N.

Due to the short processing times described in the method, continuous serial production can be operated in the production of the NTC thermistor elements 4 instead of a conventionally operated batch wise production.

This means that the required production facilities can be considerably reduced in size. A sufficiently high output can thus be achieved, for example, with a simultaneous serial production of five elements each instead of a simultaneous batch wise production of hundreds of elements.

Further, due to the omission of thermal pre-and post-treatment steps, parts of the production facilities can also be omitted.

For example, ovens in which in conventional processes aging steps of the thermistor ceramic material and curing and tempering steps of the coating layers are conducted can be omitted or drastically reduced in size.

For example, a production line of the new method measures 3.5×2 m in length and width and comprises three modules for soldering, coating and post-thermal treatment. The modules are small since only five elements have to be produced in parallel. The post-thermal treatment module comprises a small oven for accommodating the thermistor elements for 1 hour.

On the other hand, a conventional production line measures, for example, 14×5 m in length and width and comprises five modules for soldering, aging, coating, curing and tempering. The modules are comparably larger as several hundred elements have to be produced in parallel to achieve the same production capacity as with the new method. The post-thermal treatment modules for curing and tempering comprise huge ovens for accommodating hundreds of thermistor elements for up to 80 hours.

1-15. (Cancelled)

16. A method for assembling NTC sensors, the method comprising:
providing an NTC thermistor element and connection wires having terminals for contacting the NTC thermistor element; and
self-heating the NTC thermistor element while applying an electrical current during the following steps:
dispensing solder paste to the terminals of the connection wires;
applying the connection wires to the NTC thermistor element; and
melting the solder paste by a generated heat of the NTC thermistor element thereby forming solder bonds between the NTC thermistor element and the connection wires.

17. The method according to claim 16, wherein the NTC thermistor element is heated to more than 200° C.

18. The method according to claim 16, wherein the electrical current is applied by auxiliary electrodes applied to the NTC thermistor.

19. The method according to claim 16, wherein two connection wires are applied on two opposing side faces of the NTC thermistor element.

20. The method according to claim 16, wherein the solder paste is impregnated by dipping the connection wires into a reservoir containing a fluxing agent.

21. The method according to claim 16, wherein the solder paste melts and forms the solder bonds in less than 30 seconds.

22. The method according to claim 16, wherein the steps are performed in the given order.

23. A method for coating NTC sensors comprising, the method comprising:
providing an NTC sensor comprising an NTC thermistor element and connection wires fixed on the NTC thermistor element; and
self-heating the NTC thermistor element while an electrical current during the following steps:
dipping the NTC thermistor element in a coating raw material;
melting the coating raw material by the heat generated by the NTC thermistor element; and
forming a coating layer enclosing the NTC thermistor element and adjacent portions of the connection wires.

24. The method according to claim 23, wherein the NTC thermistor element is heated to more than 170° C.

25. The method according to claim 23, wherein applying the electrical current by using the connection wires.

26. The method according to claim 23, wherein the coating raw material melts and forms the coating layer in less than 30 seconds.

27. The method according to claim 23, wherein the steps are performed in the given order.

28. The method according to claim 27, wherein several NTC thermistor elements are handled simultaneously.

29. A NTC sensor element comprising:
an NTC thermistor element;
two connection wires fixed on opposing sides of the NTC thermistor element by solder bonds; and
a single-layer coating completely enclosing the NTC thermistor element and the solder bonds.

30. The NTC sensor element according to claim 29, wherein the solder bonds between the connection wires and the NTC thermistor element show a high strength of more than 6 N.

31. The NTC sensor element according to claim 29, wherein the NTC thermistor element has a block or disk shape and does not exceed dimensions of 3 mm×3 mm×1 mm.
